(19) United States
(12) Patent Application Publication
(10) Pub. No.: US 2007/0056106 A1
(43) Pub. Date: Mar. 15, 2007

(54) Emergency management triage bed

(76) Inventor: Thomas E. Roberts, Bristol, IN (US)

Correspondence Address: BARNES & THORNBURG LLP, P.O. BOX 2786, CHICAGO, IL, 60690-2786, US

(21) Appl. No.: 11/227,470

(22) Filed: Sep. 15, 2005

(51) Int. Cl. A61G 7/00; A61G 7/015

(52) U.S. Cl. 5/620; 5/617; 5/606

(57) ABSTRACT

A medical gurney for supporting, transporting and temporarily bedding patients in need of treatment comprising a first frame structure made from a plurality of inter-connected frame members and a porous mesh-type patient-supporting bed surface secured to the first frame structure. A portion of the first frame structure and bed surface are adjustable between horizontal and inclined positions. A second frame structure having transport wheels is removably attached to the first frame structure. Both the first and second frame structures are moveable between a transport position and a storage position when disconnected, such that the height of the medical gurney is substantially reduced when the first and second frame structures are in their storage position. Triage indications advise medical personnel of the medical status of the patient supported by the gurney.

### BACKGROUND

This disclosure relates to an emergency management triage bed 10 that is designed to be used in emergency response situations where patients need to be transported to a hospital or other location for treatment. Various types of medical transport devices are used to move injured or sick individuals to medical facilities for treatment. These include stretchers that are carried by medical staff to an ambulance or medical facility. Gurneys having wheels are also used to transport patients from the emergency site to the hospital. Patients injured by biological agents or that have been injured by hazardous materials require decontamination as part of their medical treatment. Existing medical gurneys cannot be decontaminated due to the nature of their construction. In order for the decontamination to occur, patients are removed from the gurneys before they can receive treatment. Further, existing medical gurneys are costly and cannot be easily stored in large quantities preventing them from being available in the event a large scale emergency response is required.

In view of the above, it should be appreciated that there is a need for an emergency management triage bed that can be easily stored, is lightweight, and permits the decontamination of a patient without removing the patient from the bed. The present disclosure satisfies these and other needs and provides further related advantages.

### SUMMARY

The invention comprises an emergency management triage bed that is used in emergency response situations prior to admitting the patient to a hospital. The emergency management triage bed is in the form of a gurney that can be utilized in multi-casualty situations or in situations where decontamination is required due to exposure to biological, hazardous or other agents. The emergency management triage bed is comprised of a plurality of frame members interconnected to form a first frame structure. At least a portion of the frame structure is adjustable from a horizontal position to an inclined position to permit elevation of the head and upper torso of the patient's body. The bed also includes a bedding surface stretched over and connected to the frame structure by use of a plurality of straps. The bed further includes a secondary frame structure releasably connected to the first frame structure and includes a plurality of wheels to allow the bed to be transported from one location to another. The secondary frame structure can be adjusted from a transport position to a storage position, reducing the height of the bed to allow for storage. When in the storage position, the emergency management triage beds can be stacked multiple units high so that a greater number of beds can be stored in a given location. The triage beds also include a plurality of colored flags that are use to indicate the severity of the patient's injuries during a triage situation.

Other features and advantages of the invention will be set forth in part in the description which follows and the accompanying drawings, wherein the embodiments of the disclosure are described and shown, and in part will become apparent upon examination of the following detailed description taken in conjunction with the accompanying drawings.

### BRIEF DESCRIPTION OF THE DRAWINGS

The above-mentioned and other features of this disclosure in the manner of obtaining them will become more apparent and the disclosure itself will be best understood by reference to the following description of elements of the disclosure taken in conjunction with the accompanying drawings in which:

FIG. 1 is a perspective view of the emergency management triage bed;

FIG. 2 is another perspective view of the emergency management triage bed shown with the head support in an inclined position;

FIG. 3 is a perspective view of the emergency management triage bed with the lower frame structure removed;

FIG. 4 is a perspective view of the emergency management triage bed with the lower frame structure removed;

FIG. 5 is an elevational view of the underside of the emergency management triage bed;

FIG. 6 is an end elevational view of the emergency management triage bed;

FIG. 7 is a perspective view of the lower frame structure of the emergency management triage bed;

FIG. 8 is a perspective view of the lower frame structure of the emergency management triage bed in a storage position;

FIG. 9 is a side elevational view of the upper frame structure of the emergency management triage bed;

FIG. 10 is a perspective view of the emergency management triage bed with an alternate lower frame structure assembly;

FIG. 11 is an elevational view of the bottom of the emergency management triage bed connected with the alternate lower frame structure;

FIG. 12 is a side elevational view of the alternate lower frame structure; and

FIG. 13 is a perspective view of the alternate lower frame structure.

### DETAILED DESCRIPTION

While the present invention will be described fully herein with reference to the accompanying drawings, in which a particular embodiment is shown, it is to be understood that the person skilled in the art may modify the disclosure herein described while still achieving the desired result of this disclosure. Accordingly, the description that follows is to be understood as a broad and informative disclosure directed to persons skilled in the appropriate art and not as limitations on the present disclosure.

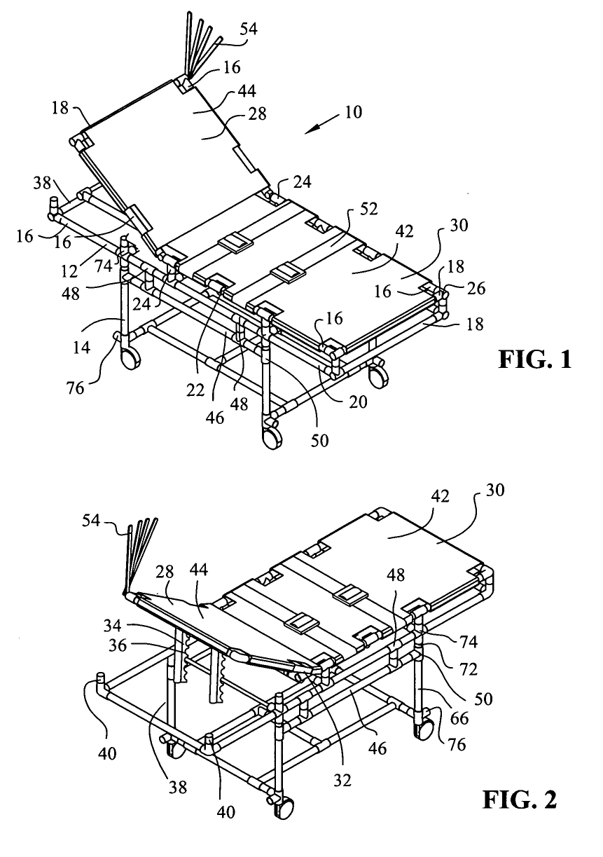

As illustrated in the drawings, an emergency management triage bed 10 is adapted to transport patients from an emergency site to a hospital or can be used as temporary bedding in a mass casualty situation. FIG. 1 illustrates the emergency management triage bed 10 which is comprised of an upper frame structure 12 removably connected to a lower frame structure 14. The upper and lower frame structures 12, 14 are preferably manufactured from a polymer such as polyvinylchloride (pvc) because it is light weight and can be decontaminated without causing damage to the structure or physical appearance of the emergency management triage bed 10.

The upper frame structure 12 is formed from a plurality of tubular side frame members 16 and tubular end frame members 18. The tubular side frame members 16 are interconnected by use of connectors 24, which are secured to the connectors 24 by use of fasteners such as screws or rivets or preferably by use of an adhesive. The tubular side frame connector 16 are interconnected with the tubular end frame members 18 by use of corner connectors 26. The corner connectors 26 are secured to the frame members 16, 18 by use of fasteners or an adhesive.

The first frame section 20 of the emergency management triage bed 10 includes a head portion 28 that is pivotally connected to a torso portion 30 of the first frame section 20 by a pair of hinges 32, as shown in FIG. 2. The head portion 28 of the first frame section 20 includes an adjustable support brace 34 that includes a plurality of notches 36 that are adapted to engage end bar 38 so that the angular inclination of the head portion 28 of the first frame section 20 can be adjusted based upon the needs of the patient and/or the medical personnel.

The second frame section 22 of the upper frame structure 12 includes support post 40 that is adapted to support the head portion 28 of the first frame section 20 when placed in a horizontal position. The torso portion 30 of the first frame section 20 of the upper frame structure 12 includes a mesh bedding surface 42. The bedding surface 42 is adapted to support the patient and is preferably made from a polyester mesh having a pvc coating, which is designed to resist degradation during decontamination. The use of a polyester mesh also provides breathability, is easy to clean and dries quickly. While polyester is used, other bedding surfaces and materials may be used to reach the desired result. The mesh bedding surface 42 is adapted to extend over the tubular frame members 16, 18 of the first frame section 20 and is secured by a plurality of straps (not shown). The head portion 28 of the first frame section 20 also includes a bedding surface 44 that is made from a polyester mesh material. The bedding surface 44 of the head portion 28 is stretched over and retained to the tubular frame members 16, 18 by use of a plurality of straps (not shown). The bedding surfaces 42, 44 are designed so that they may be removed from the upper frame structure 12 for cleaning or replacement.

The second frame section 22 is connected to the first frame section 20 by use of the connectors 24. The second frame section 22 includes a pair of bracing members 46 that are secured to the second frame section 22 of the upper frame structure 12 by use of pivoting connectors 48. The bracing members 46 are adapted to pivot from a horizontal position to a vertical position about the pivoting connectors 48. The bracing members 46 include pass through supports 50 that are adapted to engage and support the lower frame structure 14 when the lower frame structure 14 is in a transport position.

The upper frame structure 12 further includes a pair of patient securing straps 52 that are connected to the upper frame structure 12 and are used to secure the patient to the emergency management triage bed 10 while transporting the patient. The upper frame structure 12 of the emergency management triage bed 1O also includes a plurality of triage flags 54. The triage flags 54 are used in triage situations to allow the treating staff to rate the condition of the patient so that more severely injured patients can be treated first. In addition to the triage flags 54, timers and or clocks may be used in place or in addition to the triage flags 54 in order to indicate the time the patient was admitted and the duration they have been waiting for treatment.

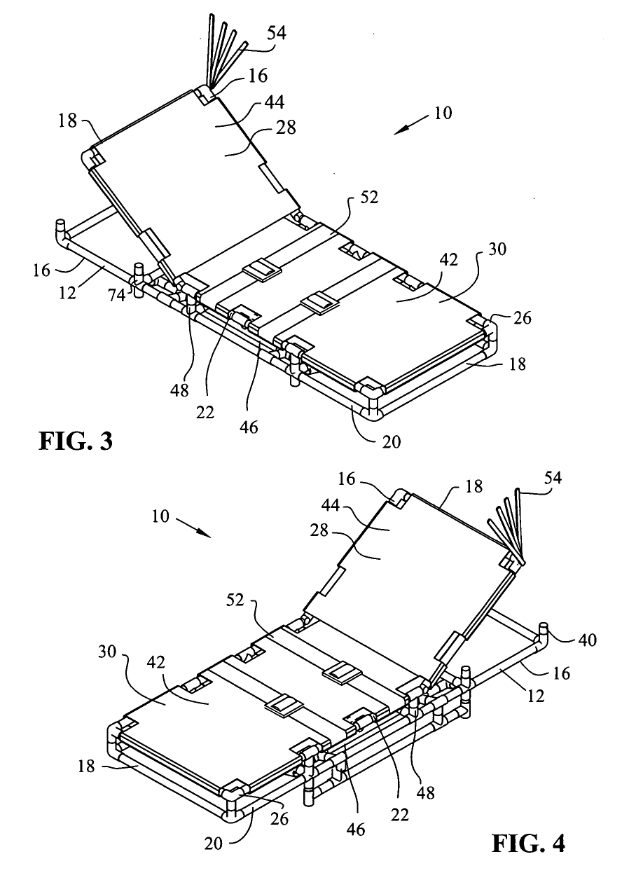

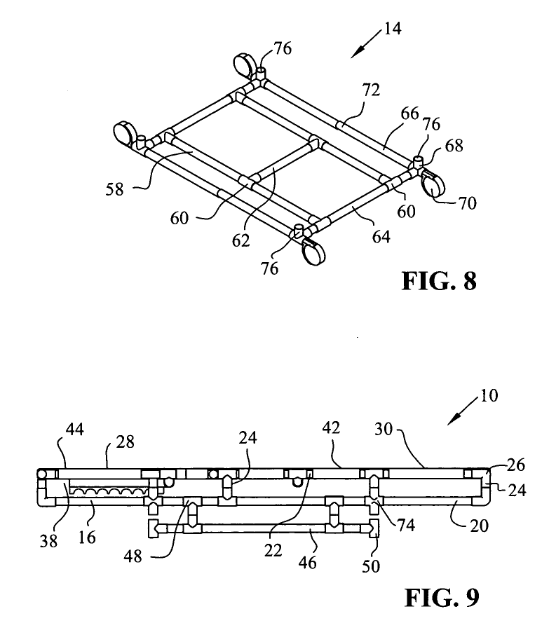

FIGS. 3 and 4 illustrate the emergency management triage bed 10 with the lower frame structure 14 removed from the upper frame structure 12. In this position, the bracing members 46 are pivoted inward so that the second frame section 22 of the upper frame structure 12 rests firmly upon the ground. The bracing members 46 are pivoted inward when the lower frame structure 14 is connected in a storage position, as shown in FIG. 8.

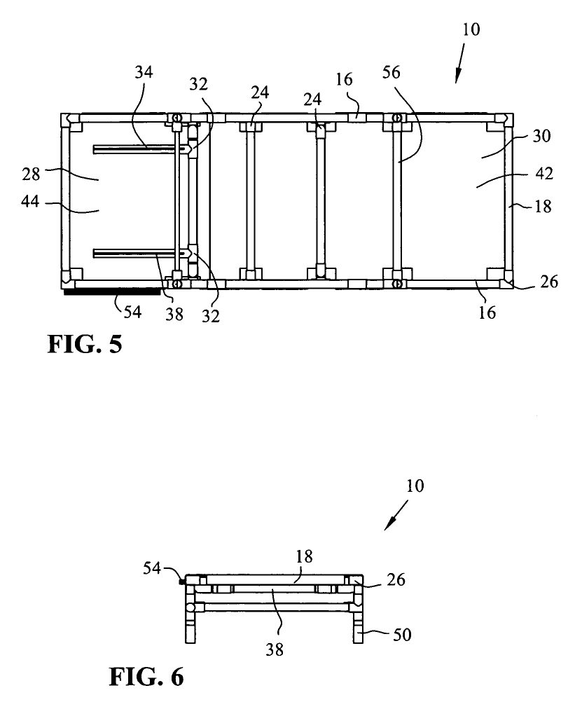

The upper frame structure 12 also includes a plurality of cross supports 56, as shown in FIG. 5, that are joined with connectors 24. The cross supports 56 of the upper frame structure 12 assist in maintaining the structural integrity of the emergency management triage bed 10.

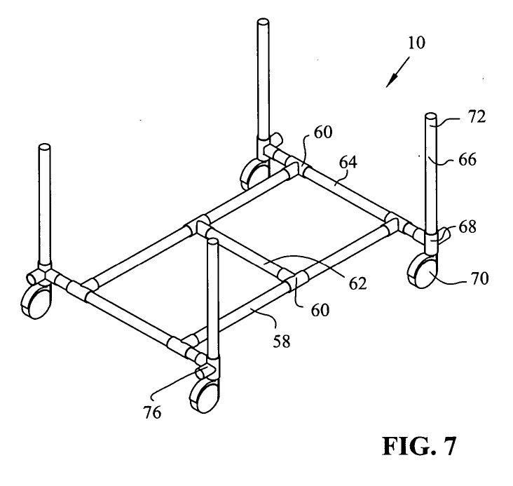

The lower frame structure 14, as shown in FIGS. 7 and 8, includes a pair of parallel longitudinal members 58 that are connected to t-members 60 at the center of the longitudinal numbers 58. Bracing member 62 is connected to the longitudinal members 58 by t-members 60. The lower frame structure 14 includes end members 64 that are pivotally attached to the t-members 60. The lower frame structure 14 includes a plurality of upstanding legs 66 that are connected to wheel connectors 68. The wheel connectors 68 are rigidly connected to end members 64. Also attached to the wheel connectors 68 are a plurality of casters 70 that permit the emergency management triage bed 1O to be moved between locations. The casters 70 are of the lockable type to prevent unwanted movement of the management triage bed 10. The legs 66 include a top end 72 that are adapted to pass through pass through supports 50 and into support tees 74 as shown in FIG. 2.

The casters 70 are pivotally connected to the wheel connectors 68 so that the bed 10 can be moved in multiple directions. The wheel connectors 68 include connection ports 76 that are adapted to be connected to the support tees 74 when the legs 66 are folded inward to a storage position, as shown in FIG. 8.

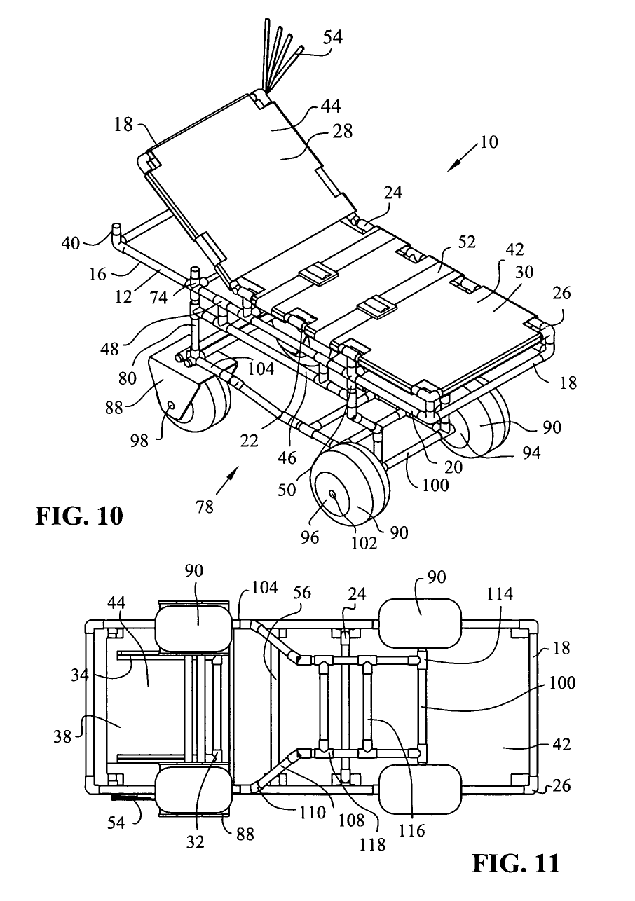

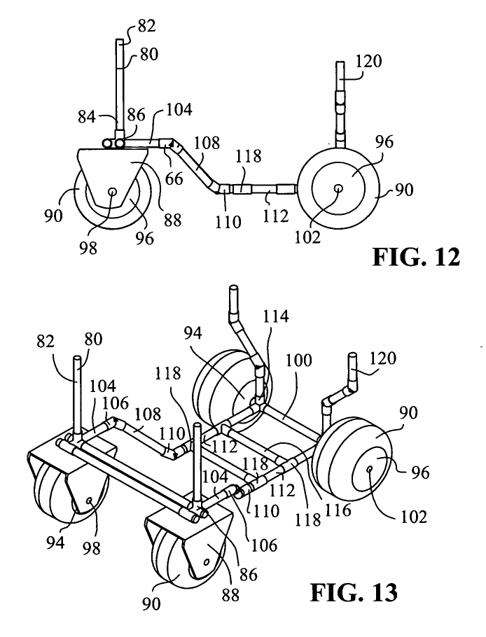

FIGS. 10 through 13, of the application, illustrate an alternate embodiment of a lower frame structure 78 that is adapted to be used in combination with the upper frame structure 12 of the emergency management triage bed 10. The lower frame structure 78 of the emergency management triage bed 10 is adapted to be used in situations where transportation of an injured patient using an emergency management triage bed 10 with standard casters would not be possible. This arrangement is particularly useful in situations where a patient has been injured in a sandy area such as a beach or where uneven terrain would prevent use of standard casters.

The lower frame structure 78 is comprised of a pair of front supports 80 that include a top end 82 and a space apart bottom end 84. The top end 82 of the front supports 80 are adapted to be positioned within the support tees 74 of the upper frame structure 12. The bottom end 84 of the front supports 80 are adapted to be connected to wheel connectors 86 that, in turn, are connected to a pair of pivoting wheel assemblies 88. The wheel assemblies 88 are connected to a pair of semi-spherical pneumatic wheels 90.

The semi-spherical wheels 90 of the lower frame structure 78 include a semi-spherical tire 92 secured to inner and outer plates 94, 96. The wheels 90 are connected to the wheel assemblies 88 by use of axles 98. The wheels 90 are connected to a rear axle housing 100 by use of axle 102.

The lower frame structure 78 includes a pair of horizontal frame members 104 that are connected to angled connectors 106 which are, in turn, connected to down tubes 108. The down tubes 108 of the lower frame structure 78 are connected to a second set of angled connectors 110 that are connected to a pair of frame rails 112. The frame rails 112 are secured to a pair of tee connectors 114 and are stiffened by a pair of cross members 116 that are connected by tees 118. The rear of the lower frame structure 78 includes a pair of offset support members 120 that are adapted to be connected with support tees 74.

In use, the emergency management triage bed 10 is arranged so that the bracing members 46 are vertically oriented and the legs 66 of the lower frame structure 14 are in an upright position. To connect the lower frame structure 14 to the upper frame structure 12, the legs 66 of the lower frame structure 14 are inserted through the pass through supports 50 of the upper frame structure 12 and are secured within the support tees 74. With the lower frame structure 14 securely in place, a patient can be positioned upon the bedding surface 42 and retained by securing belts 52. If it is necessary, the head portion 28 of the upper frame structure 12 can be inclined and locked into position by use of the adjustable brace 34. Depending upon the condition of the patient, various triage flags 54 can be raised to indicate to the medical personnel the condition of the patient. When the emergency management triage bed 10 is not in use, the lower frame structure 14 can be removed and the legs 16 can be pivoted inward so that connection ports 76 of the lower frame structure 14 are positioned in upward direction.

Once the connection port 76 is positioned in an upward direction and the bracing members 46 of the upper member 12 are pivoted inward to a horizontal position the connection parts 76 can be connected with the support tees 74. The storage position lowers the overall height of the emergency management triage bed 10 so that it is within close proximity to the ground. In this arrangement, the emergency management triage bed 10 can be stacked at least five units high to conserve storage space when multiple emergency management triage bed 10 are stored.

The upper frame structure 12, the lower frame structure 14 and the bedding surfaces 42, 44 are manufactured from a polymer material, allowing the emergency management triage bed 10 and the patient thereon to be decontaminated simultaneously in the event of a chemical spill. In instances of a biological outbreak, the emergency management triage bed 10 can be burned or incinerated to prevent further contamination. In situations where the terrain prohibits use of casters 70, the lower frame structure 14 can be removed and the alternate lower frame structure 78 can be installed to allow the emergency management triage bed 10 to travel over uneven terrain. The use of wheels 90 minimizes the number of personnel needed to transport the patient to a treatment location from a remote area.

Various features of the disclosure have been shown and described in connection with the illustrated embodiment, however, it is understood that these arrangement merely illustrate, and that the disclosure is to be given its fullest interpretation.

What is claimed is:

1. A medical gurney for supporting, transporting and temporarily bedding patients in need of treatment, said medical gurney comprising:
a plurality of frame members interconnected to form a first frame structure,
a porous bed surface secured to said first frame structure, said porous bed surface adapted to support the patient;
a second frame structure removably connected to said first frame structure, said second frame structure having a transport position and a storage position, wherein the height of said medical gurney is reduced when said second frame structure is in said storage position.

2. The medical gurney of claim 1, wherein at least a portion of said frame structure is adjustable from a horizontal position to an inclined position;

3. The medical gurney of claim 1, wherein said porous bed surface comprises a mesh material that is stretched across said first frame structure before being secured thereto.

4. The medical gurney of claim 1, wherein said second frame structure is detachable from said first frame structure to allow said second frame structure to be transformed from said transport position to said storage position.

5. The medical gurney of claim 4, wherein said first frame structure has a transport position and a storage position, wherein the height of the first frame structure is reduced when said first frame structure is in said storage position.

6. The medical gurney of claim 5, wherein said medical gurney can be stacked at least five gurneys high when said first and second frame structure are in said storage positions.

7. The medical gurney of claim 1, wherein said first frame structure is made from a polymer material.

8. The medical gurney of claim 1, wherein at least 90% of said first frame structure is combustible.

9. The medical gurney of claim 1, wherein said second frame structure is made from a polymer material.

10. The medical gurney of claim 1, wherein at least 90% of said second frame structure is combustible.

11. The medical gurney of claim 1, wherein said plurality of frame members are in the form of polymer tubes that are interconnected at polymer joints to form the first frame structure.

12. The medical gurney of claim 11, wherein said porous bed surface is in the form of a mesh material that is stretched over said polymer tubes and is secured by use of web strapping.

13. The medical gurney of claim 1, wherein said second frame structure includes a plurality of wheels that permit said medical gurney to be transported.

14. The medical gurney of claim 1, wherein said porous bed surface, said first and second frame structures are adopted to withstand contamination while the patient is lying on the bed surface.

15. A light weight medical gurney for transporting and bedding patients wherein the patient and the gurney can be decontaminated simultaneously, said lightweight gurney comprising:
an upper frame structure adapted to support the weight of the patient, said upper frame structure formed from a plurality of tubular members;
a bedding layer adapted to support the weight of the patient, said bedding layer being stretched and secured to said upper frame structure;
a lower frame structure removably connected to said upper frame structure, said lower frame structure having a transport position and a storage position; said lower frame structure includes a plurality of wheels that are adapted to permit movement of said medical gurney when said lower frame structure is in said transport position.

16. The light weight medical gurney of claim 15, wherein said lower frame structure includes a first set of connectors adapted to engage and be removably secured to said upper frame structure when said lower frame structure is in said storage position, said lower frame structure including a second set of connectors adapted to engage and be secured to said upper frame structure when said lower frame structure is in said transport position.

17. The light weight medical gurney of claim 15, wherein said upper and lower frame structures are formed from polymer tubing.

18. The light weight medical gurney of claim 15, wherein said bedding layer is a polymer mesh material adapted to firmly support the patient thereon, said bedding layer secured to said upper frame structure by a plurality of straps.

19. The light weight medical gurney of claim 15, wherein said wheels of said lower frame structure are each comprised of a semi-spherical air chamber connected to a rim structure and adapted to be rotatably secured to said lower frame structure, said wheels adapted to permit movement of said medical gurney over loose terrain.

20. The light weight medical gurney of claim 15, wherein said gurney includes indicia to indicate the level of severity of the patient's injuries in a triage situation.

21. The light weight medical gurney of claim 15, wherein said medical gurney and the patient can be simultaneously decontaminated while the patient is lying on said bed.

22. The light weight medical gurney of claim 15, wherein said gurney includes handles to permit said gurney to be carried by a single person.

23. The light weight medical gurney of claim 15, wherein the gurney can be stacked at least five gurneys high when said lower frame structure is in a storage position.

24. The light weight medical gurney of claim 15, wherein at least a portion of said upper frame structure can be adjusted from a horizontal position to an inclined position.
